(19) United States
(12) Patent Application Publication
(10) Pub. No.: US 2012/0267277 A1
(43) Pub. Date: Oct. 25, 2012

(54) Color Changeable Carrier and Method

(76) Inventors: Tracy Frederick, Friendswood, TX (US); Terry Frederick, Friendswood, TX (US)

(21) Appl. No.: 13/426,348

(22) Filed: Mar. 21, 2012

Related U.S. Application Data
(60) Provisional application No. 61/477,041, filed on Apr. 19, 2011.

(51) Int. Cl. B65D 30/02; A45F 3/00; B05D 7/24

(52) U.S. Cl. 206/459.1; 29/458

(57) ABSTRACT

The present application is directed to a color changeable carrier constructed from at least one dye-laden material, wherein the dye-laden material is treated in a manner effective to provide one or more first visible colors under predetermined ambient conditions and one or more second visible colors under different predetermined ambient conditions.

### CROSS-REFERENCE TO RELATED APPLICATIONS

The application is entitled to the benefit of the filing date of the prior-filed provisional application No. 61/477,041, filed on Apr. 19, 2011.

### STATEMENT REGARDING FEDERALLY SPONSORED RESEARCH OR DEVELOPMENT

Not applicable.

### FIELD OF THE APPLICATION

The application relates generally to carriers constructed from materials operationally configured to change color under one or more ambient conditions.

### BACKGROUND

There are many types of carriers on the market. For example, purses are commonly used by ladies to carry personal items. Backpacks are commonly used by students to carry school related items and luggage is typically used by travelers. Depending on the intended use and in some cases depending on trends in fashion, commercially available carriers may be sold in one or more particular color schemes, patterns and/or designs as the market demands. Unfortunately, the outer appearance of commercially available carriers is static resulting in boredom to a consumer possibly leading to further costly and/or unnecessary purchases over time.

It is desirable to provide a carrier operationally configured to change in outer appearance.

### SUMMARY

The present application is directed to a color changeable carrier constructed from at least one dye-laden material, wherein the dye-laden material is treated in a manner effective to provide one or more first visible colors under predetermined ambient conditions and one or more second visible colors under different predetermined ambient conditions.

The present application is also directed to a carrier constructed at least in part from one or more thermochromic dye-laden materials, the thermochromic dye-laden material being disposed along the outer surface of the carrier in a manner effective to produce one or more first visible colors at ambient temperatures ranging from about −35.0 to about 125.0 degrees Celsius.

The present application is also directed to a method of producing a color changeable carrier including (1) providing one or more textile materials and one or more thermochromic dyes; (2) applying one or more layers of thermochromic dye to the surface of the one or more textile materials in a manner effective to substantially cover the surface of the one or more textile materials; (3) curing the one or more textile materials in a manner effective to provide one or more first visible colors of the materials at a particular ambient temperature; and (4) assembling the one or more textile materials to form a carrier.

### BRIEF DESCRIPTION OF THE FIGURES

FIG. 1 is a perspective view of a carrier of this application, the carrier having a yellowish exterior surface color.

FIG. 2 is a perspective view of a carrier of this application, the carrier having a reddish exterior surface color.

FIG. 3 is a perspective view of a carrier of this application, the carrier having a yellowish exterior surface color.

FIG. 4 is a perspective view of a carrier of this application, the carrier having a reddish exterior surface color.

FIG. 5 is a perspective view of a carrier of this application, the carrier having a brownish exterior surface color.

FIG. 6 is a perspective view of a carrier of this application, the carrier including a hand print configuration on the surface of the carrier in a visible color(s) other than the color(s) of the remaining carrier surface.

FIG. 7 is a perspective view of a carrier of this application including a mark on the carrier surface made by a finger of the individual, the mark having a color(s) other than the color(s) of the remaining carrier surface.

FIG. 8 is a front view of a carrier of this application at a first ambient condition including a handle and pocket visible as the color white.

FIG. 9 is the carrier of FIG. 8 at a different ambient condition including a handle and pocket visible as the color black.

FIG. 10 is a front view of a carrier of this application at a first ambient condition, the exterior surface of the carrier visible as the color white.

FIG. 11 is the carrier of FIG. 10 at a different ambient condition, the carrier providing a visible peace sign constructed from one or more color changeable materials.

FIG. 12 is a front view of a carrier of this application at a first ambient condition, the exterior surface of the carrier visible as the color white.

FIG. 13 is the carrier of FIG. 12 at a different ambient condition, the carrier providing a zebra stripe pattern constructed from one or more color changeable materials.

### BRIEF DESCRIPTION

It has been discovered that a carrier can be manufactured to provide one or more visible colors on the outer surface of the carrier in one or more patterns under different ambient conditions. Heretofore, such a desirable achievement has not been considered possible, and accordingly, this application measures up to the dignity of patentability and therefore represents a patentable concept.

Before describing the invention in detail, it is to be understood that the present carrier is not limited to particular embodiments. It is also to be understood that the terminology used herein is for the purpose of describing particular embodiments only, and is not intended to be limiting. As used in this specification and the appended claims, the term “carrier” refers to a device used by an individual for carrying various items. Suitable carriers may include, but are not necessarily limited to bags, sacks, purses, backpacks, satchels, luggage, pouches, rucksacks, cases, binders, notebook type cases, lunch boxes, and other toteable objects and devices. The phrase “trigger event” refers to one or more changes in ambient conditions. The phrase “ambient conditions” refers to temperatures, humidity levels, electromagnetic radiation, and combinations thereof that the carriers of this application may be exposed to over time.

In one aspect, the application provides carriers constructed from one or more materials operationally configured to change color under varying ambient conditions.

In another aspect, the application provides carriers constructed from one or more materials dyed with one or more coloring agents operationally configured to change color in response to changes in one or more ambient conditions.

In another aspect, the application provides carriers constructed from one or more materials coated with one or more coloring agents operationally configured to change color in response to changes in one or more ambient conditions.

In another aspect, the application provides carriers constructed from one or more materials including one or more coloring agents operationally configured to change color in response to changes in light frequency directed to the outer surface of the carrier.

In another aspect, the application provides carriers constructed from one or more materials coated with one or more coloring agents operationally configured to change color in response to changes in ultra-violet light directed to the outer surface of the carrier.

In another aspect, the application provides carriers constructed from one or more materials operationally configured to change color upon contact by individuals.

In another aspect, the application provides carriers constructed from one or more color changeable and non-color changeable materials.

In another aspect, the application provides carriers operationally configured to change in outward appearance from a first visible color to a second visible color upon the occurrence of a trigger event.

In another aspect, the application provides carriers operationally configured to change in outward appearance through a series of colors under different ambient conditions.

In another aspect, the application provides carriers including color changeable materials operationally configured to convey one or more messages via color changing designs, words, shapes, patterns, symbols, and the like under different ambient conditions.

In another aspect, the application provides a carrier system including color changeable sections that may be releasably attached to the carrier as desired.

In another aspect, the application provides carriers that may be assembled using any combination of color changeable and non-color changeable materials to meet the particular needs of an individual, group, team, organization, association, affiliation, government body, and the like.

In another aspect, the application provides carriers constructed from one or more materials operationally configured to produce one or more first visible colors at an initial temperature. The one or more materials may display one or more designs and/or words and/or shapes and/or patterns and/or symbols and/or imprints of one or more second colors upon contact by an individual, for example, by touch of a hand or finger upon the outer surface of the carrier.

In another aspect, the application provides carriers constructed from one or more color changeable materials operationally configured to change color when the temperature rises above or drops below a pre-defined temperature and/or when the ambient light reaches a pre-defined frequency.

In another aspect, the application provides a carrier constructed from one or more materials containing an ambient-condition-dependent color-changing additive.

In another aspect, the application provides a carrier constructed from one or more materials including one or more thermochromic dyes.

In another aspect, the application provides carriers constructed from one or more materials including one or more photochromic dyes.

In another aspect, the application provides carriers constructed from one or more materials including one or more thermochromic dyes operationally configured to change color at one or more predetermined temperatures.

In another aspect, the application provides carriers constructed from one or more materials including one or more thermochromic dyes operationally configured to change color at one or more predetermined minimum temperatures.

In another aspect, the application provides carriers constructed from one or more materials including one or more thermochromic dyes operationally configured to change color at one or more predetermined maximum temperatures.

In another aspect, the application provides carriers constructed from one or more materials including one or more thermochromic dyes operationally configured to change color at one or more predetermined temperatures. As desired, the one or more materials may include one or more outer protective coatings to guard against chipping, cracking as a result of ozone, weathering, heat, moisture, other outside mechanical and chemical influences, as well as various impacts. In one embodiment, the carrier may include an ultra-violet light protectable varnish applied to the exterior surface of the carrier. In another embodiment, the carrier may include water repellant applied to the exterior surface of the carrier.

In another aspect, the application provides carriers constructed from one or more materials coated with one or more thermochromic dyes. The dyes may be temperature activated as desired.

In another aspect, the application provides carriers constructed from one or more thermochromic dye-laden materials, the carrier materials being operationally configured to hold loads of up to about 136.1 kg (about 300 pounds).

In another aspect, the application provides carriers constructed from one or more dye-laden materials, the dye comprising a solvent based ink formulation including a reversible thermochromic coloring material that exhibits a visible change in color between a first color state and a second color state in response to a change in ambient temperature.

### Discussion of the Carrier and Method

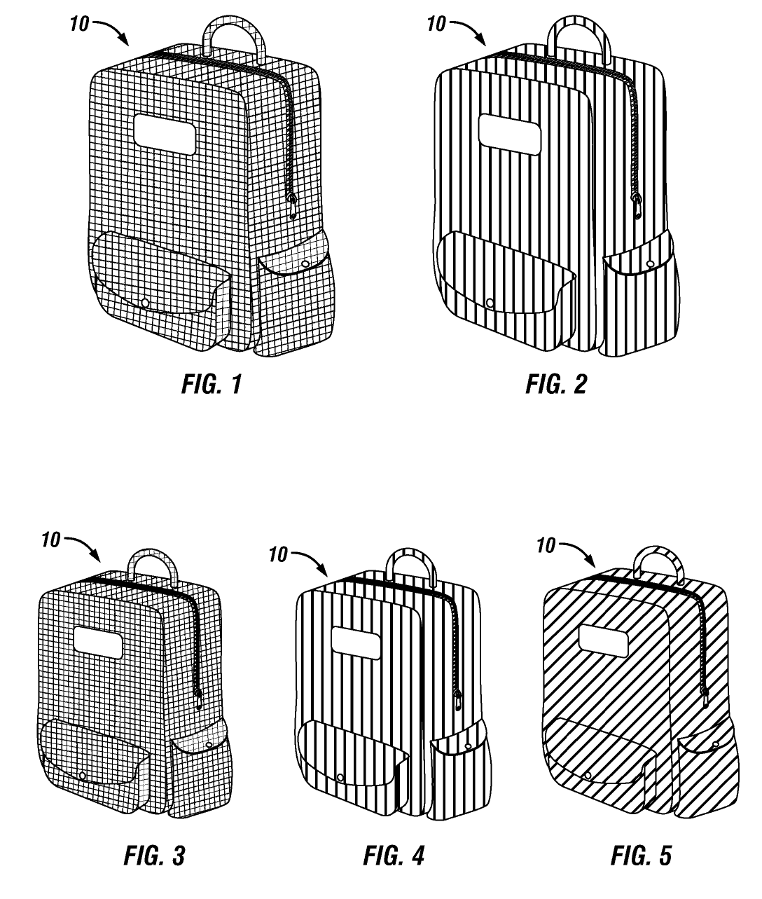

To better understand the novelty of the carrier, reference is hereafter made to the accompanying drawings. With reference now to a simplified illustration of the invention as provided in FIG. 1, a carrier 10 in the form of a backpack is provided, the carrier 10 having an outer surface defined by one or more materials operationally configured to change color under various ambient conditions. Suitably, the one or more materials may be assembled together in a manner effective to change the outer appearance of the carrier 10 under various ambient conditions as desired.

In one embodiment, substantially the entire outer surface of the carrier 10 may be constructed from one or more color changeable materials, less zippers and such, effective to produce a visible color or combination of visible color(s) both prior to and following one or more trigger events. For example, the outer surface of the carrier 10 of FIGS. 1-2 is defined by about 95.0 percent or more of color changeable material. In an embodiment of a carrier 10 including materials having a combination of visible colors, any one particular visible color may define from about 0.01 to about 99.99 percent of the outer surface of the color changeable material of a carrier 10.

In another embodiment, the carrier 10 may be constructed from a combination of color changeable and non-color changeable materials effective to produce one or more visible colors both prior to and following one or more trigger events. In such embodiment, the non-color changeable materials may comprise from about 0.01 to about 99.99 percent of the outer surface of the carrier 10.

For the purposes of this application, suitable materials for carrier 10 construction include those materials operationally configured to receive one or more color changeable additives in a manner effective to provide at least a first visible color or colors under certain ambient conditions. Suitable materials include, but are not necessarily limited to woven textiles, nonwoven textiles, leather, leather substitutes, and combinations thereof. Suitable textiles may include animal textiles, synthetic textiles, plant textiles, and combinations thereof. Suitable animal textiles may include, but are not necessarily limited to wools, silks, and combinations thereof. Suitable synthetic textiles may include, but are not necessarily limited to polyester fibers and derivatives thereof, aramid, acrylics, nylons, spandex, rayon, olefin fibers, polyactide fibers, lurex, rubbers, plastics, and combinations thereof. Suitable plant textiles may include, but are not necessarily limited to cotton, linen, hemp and combinations thereof. Without limiting the invention, the color changeable materials used herein may be operationally configured to provide similar functional characteristics as those materials currently known in the art of carriers. For example, the present color changeable materials may exhibit one or more of the following characteristics: durability, flexibility, lightweight, water-impermeability, and breathability. As such, the color changeable material used may be provided in single layers or in multi-layer form of carrier 10 construction.

Without limiting the invention, suitable color changeable additives may include, but are not necessarily limited to thermochromic dyes, photochromic dyes, and combinations thereof. As such, a suitable trigger event for carriers 10 constructed from material comprising one or more of the above listed additives may include a change in ambient temperature, a change in electromagnetic radiation directed onto the outer surface of the carrier 10, and combinations thereof.

More particularly, the carrier 10 materials used may include one or more color changeable chemicals in an amount effective to produce one or more first visible colors under certain ambient conditions. Upon the occurrence of one or more trigger events, the one or more color changeable chemicals may react in a manner effective (1) to change from one or more first visible colors to one or more second visible colors, or (2) to change through a series of visible colors as desired.

As understood by persons of ordinary skill in the art of dyes, thermochromic dyes change colors based on chemical reactions resulting from changes in ambient temperature. In one embodiment, suitable thermochromic dyes may include, but are not necessarily limited to liquid crystals, micro-encapsulated dyes, and combinations thereof. As understood in the art, liquid crystals and micro-encapsulated dyes are operationally configured to display different visible colors at different ambient temperatures.

Suitable liquid crystal thermochromic dyes are provided as liquid crystals contained in tiny capsules. The liquid crystals are cholesteric, meaning that the liquid crystal molecules arrange themselves in a very specific helical structure reflecting certain wavelengths of light at an initial temperature to produce one or more first visible colors. As the liquid crystals heat up or cool down, the orientation of the helices change, which causes the helices to reflect a different wavelength of light—resulting in a change in visible color. Thereafter, as the crystals reorient themselves back into their initial arrangements, the material returns to the one or more first visible colors.

Suitable micro-encapsulated thermochromic dyes, or “Leuco dyes” as understood by persons of ordinary skill, contain millions of tiny capsules or microcapsules, each capsule having an outer membrane and containing an organic, hydrophobic solvent to prevent dilution or washing out of the chemicals in the dye. The solvent contains particles of a color developer and a dye precursor. As the capsule heats up, the solvent melts and a chemical reaction causes the color developer to donate a proton to the dye precursor. In turn, this causes the precursor to develop into the dye itself and change color. When the dye cools down, the developer and precursor separate, the solvent resolidifies and the color returns to its original state. Suitably microcapsules range in size from about 0.5 to about 10.0 μm.

Thermochromic dye may be applied to a material in an amount and in a manner effective to produce one or more first visible colors of the carrier 10 material when the carrier 10 is exposed to a particular ambient temperature or temperature range (hereafter referred to as the “initial temperature”). Once the dye is subjected to a temperature or temperature range other than the initial temperature, the dye may undergo a chemical reaction, i.e., activated to produce one or more second visible colors of the carrier 10 material. For the purposes of this application, thermochromic dyes may be activated at temperatures ranging from about −35.0 to about 125.0 degrees Celsius (from about −31.0 to about 275.0 degrees Fahrenheit). In other words, the thermochromic dyes of this application may be effective to provide at least one first visible color at temperatures between −35.0 to 125.0 degrees Celsius (−31.0 to 275.0 degrees Fahrenheit). In general, the greater the volume or amount of dye that is applied to a material the greater the intensity of a first visible color at an initial temperature, and vice versa.

In one embodiment, the thermochromic dye may include a water-based thermochromic ink characterized by a mixture of thermochromic pigments and a binder, the ink being operationally configured to provide at least a first visible color or colors at a predetermined ambient temperature. In one simplified embodiment, the thermochromic ink may be applied to a material in an amount effective to provide at least one first visible color at ambient temperatures up to about 21.99 degrees Celsius (about 71.58 degrees Fahrenheit). In another simplified embodiment, the thermochromic ink may be applied to a material in an amount effective to provide a first visible color at ambient temperatures up to about 26.99 degrees Celsius (about 80.58 degrees Fahrenheit). Above these temperatures, i.e., at activation temperatures of (1) about 22.0 degrees Celsius, and (2) about 27.0 degrees Celsius respectfully, the thermochromic ink is effective to produce one or more second visible colors.

In one embodiment, the thermochromic ink may change from a first visible color to a second visible color once the ambient temperature reaches a predetermined activation temperature. In another embodiment, the thermochromic ink may begin changing from a first visible color to a second visible color at an activation temperature and completely changes to the second visible color once a predetermined final ambient temperature is realized. For example, the thermochromic ink may be applied to a material in an amount effective to provide a first visible color at ambient temperatures up to about 26.99 degrees Celsius (about 80.6 degrees Fahrenheit), whereby the ink changes into a second visible color at about 29.0 degrees Celsius (about 84.2 degrees Fahrenheit). In addition, the initial temperature and/or activation temperature and/or final temperature may include a range of temperatures as opposed to one defined temperature, e.g., an activation temperature may range from about 25.0 to about 29.0 degrees Celsius (from about 77.0 to about 84.2 degrees Fahrenheit).

Without limiting the invention, the rate of color change of a carrier 10 outer surface may vary based on (1) the material of construction, (2) the type of thermochromic ink used, (3) the amount of thermochromic ink used, (4) the initial ambient temperature, (5) the ambient activation temperature, (6) the final ambient temperature, (7) abruptness in ambient temperature change, and combinations thereof. Typically, the greater the variation in temperature from an initial temperature to an activation temperature, the faster the rate of color change from a first visible color to a second visible color and the slower the rate of color change back to the first visible color. For example, if a carrier 10 is transported from an indoor ambient environment of about 22.2 degrees Celsius (about 72.0 degrees Fahrenheit) to an outdoor ambient environment of about 29.4 degrees Celsius (about 85.0 degrees Fahrenheit) a carrier 10 of this application is operationally configured to change from a first visible color to a second visible color at a rate from about 45.0 seconds to about 75.0 seconds. If transported back to the initial indoor environment, the carrier 10 is operationally configured to revert to the first visible color at a rate from about 45.0 seconds to about 75.0 seconds. In an example where a carrier 10 is transported from an indoor ambient environment of about 22.2 degrees Celsius (about 72.0 degrees Fahrenheit) to an outdoor ambient environment of about 37.8 degrees Celsius (about 100.0 degrees Fahrenheit) a carrier 10 of this application is operationally configured to change from a first visible color to a second visible color at a rate from about 15.0 seconds to about 40.0 seconds. If transported back to the initial indoor environment, the carrier 10 is operationally configured to revert to the first visible color at a rate from about 30.0 seconds to about 60.0 seconds.

Table 1 describes exemplary rates of color change for dye-laden materials of this application from one or more first visible colors to one or more second visible colors at an ambient activation temperature.

TABLE 1

| | | | Rate of |
|---|---|---|---|
| | Initial Ambient | Ambient Activation | Color Change of the |
| | Temperature of a | Temperature of a | Surface of the Carrier 10 |
| | Carrier 10 | Carrier 10 | (in seconds) |
| 1 | 23.3° C. (74.0° F.) | 26.7° C. (80.0° F.) | about 45.0 |
| 2 | 23.3° C. (74.0° F.) | 32.2° C. (90.0° F.) | about 15.0 |
| 3 | 1.7° C. (35.0° F.) | 24.4° C. (76.0° F.) | about 180.0 |
| 4 | 1.7° C. (35.0° F.) | 32.2° C. (90.0° F.) | about 120.0 |
| 5 | 35.6° C. (96.0° F.) | 2.2° C. (36.0° F.) | about 25.0 |

Table 2 describes color changing characteristics for dye-laden materials of this application from one or more first visible colors to one or more second visible colors based on contact of a human hand to the carrier 10 surface, the carrier 10 surface varying in initial ambient temperature.

TABLE 2

| | | Length of Time for |
|---|---|---|
| | | Carrier 10 Surface to |
| | | Revert Back to |
| | Length of Time of | Initial Visible |
| | Hand Contact to Produce | Color(s) following |
| | a Color Change of | Release of Hand from |
| Initial Ambient | the Carrier 10 Surface | Carrier 10 Surface |
| Temperature | (in seconds) | (in seconds) |
| 24.4° C. (76.0° F.) | about 5.0 | about 60.0 |
| 2.2° C. (36.0° F.) | about 15.0 | about 5.0 |
| −17.8° C. (0.0° F.) | about 45.0 | about 3.0 |

With attention to the simplified illustration of FIGS. 1 and 2, an exemplary carrier 10 may be constructed from a thermochromic dye-laden material providing a first visible color at an initial temperature (a yellowish color as represented in FIG. 1). Once the thermochromic dye is subjected to an ambient activation temperature, the thermochromic dye may react to produce a second visible color (a reddish color as represented in FIG. 2).

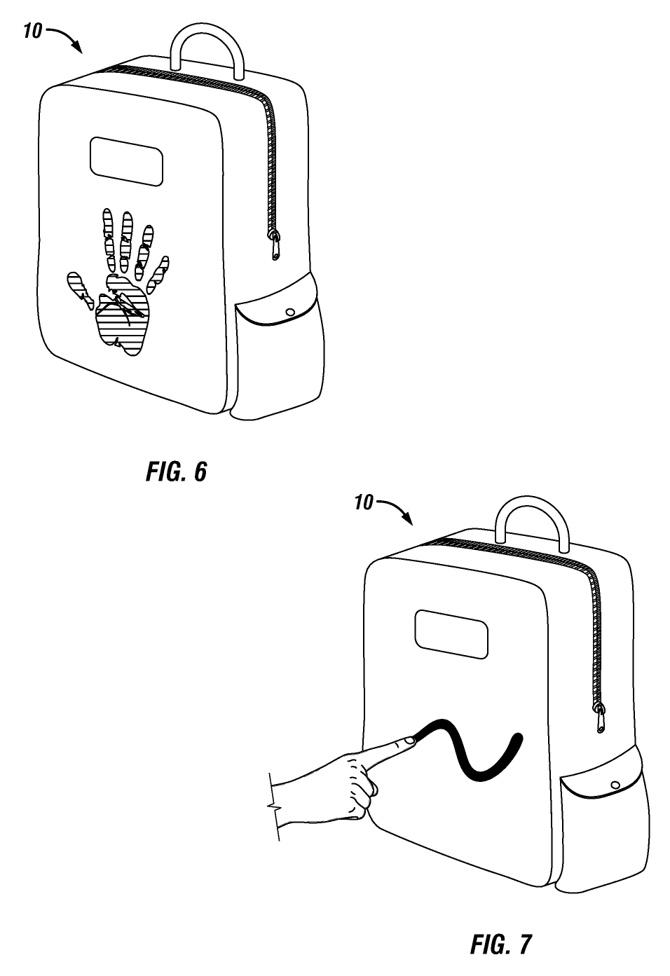

Turning to the simplified illustration of FIGS. 3-5, an exemplary carrier 10 may be constructed from a thermochromic dye-laden material providing a first yellowish color at an initial temperature (FIG. 3). Once the ambient temperature reaches an activation temperature, the thermochromic dye is suitably effective to react chemically to produce a reddish color of the material (FIG. 4). Upon further change in ambient temperature, the carrier 10 material may continue changing color realizing a final color at a final ambient temperature—represented as a brownish color in FIG. 5.

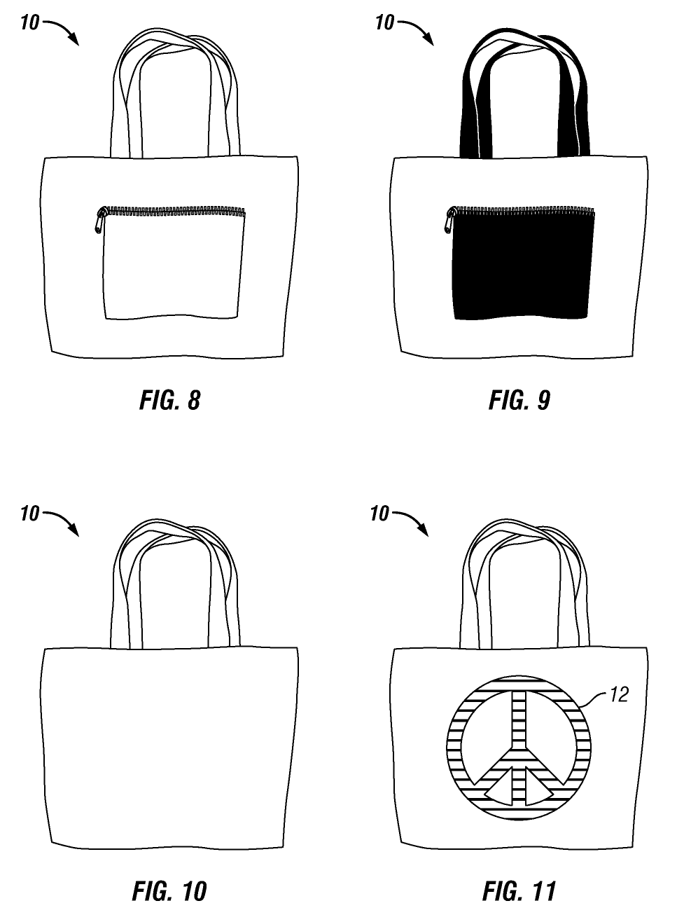

As discussed above, an exemplary carrier 10 may be constructed from one or more dye-laden materials including one or more thermochromic dyes operationally configured to change color upon contact by a person via heat transfer (see FIGS. 6-7 and Table 2). Suitably, the intensity of color change may depend on one or more factors including, but not necessarily limited to the type of thermochromic dye used, the amount of thermochromic dye used, the type of carrier 10 material employed, and the initial ambient temperature.

### Carrier Production

Without limiting the invention to a particular mode of operation, thermochromic dye may be added to a material by applying the dye to the surface of the material via one or more techniques including, but not necessarily limited to spraying, soaking, brushing, rolling on, dipping, blotting, and combinations thereof. In one suitable embodiment, the thermochromic dye may be applied by rolling the dye onto the surface of the material in a manner effective to provide one or more coats or layers of the dye that substantially covers the material surface. In another embodiment, a first coat of thermochromic dye may be sprayed onto the surface of the material where after a second coat may be rolled onto the surface of the material or vice versa. Other combinations for applying coats or layers of dye are also contemplated herein. In addition, differing types of dyes may be applied to the surface of a material in any combination as desired.

Without limiting the invention to a particular embodiment, suitable thermochromic dyes may be added to one or more materials in an ambient environment defined by an ambient temperature from about 15.0 to about 70.0 degrees Celsius (from about 59.0 to about 158.0 degrees Fahrenheit). In another embodiment, the thermochromic dye of this application may be added to one or more materials in an ambient environment defined by an ambient temperature from about 30.0 to about 60.0 degrees Celsius (from about 86.0 to about 140.0 degrees Fahrenheit). In addition, in embodiments including a plurality of layers of thermochromic dye, each layer may be allowed to cure prior to the addition of each succeeding outer layer, each succeeding layer may be applied prior to curing of the previous layer, or combinations thereof.

Once a desired amount of thermochromic dye is applied to the material, the dye may be cured in a manner effective to establish an initial temperature range of the thermochromic dye. In one embodiment, the dye-laden material may be allowed to air dry in an ambient environment the same or similar to the ambient environment where thermochromic dye was applied to the material. In another embodiment, curing of the thermochromic dye may be accomplished by heating the dye-laden material in an oven or like device. Suitable heating of the dye-laden material may be accomplished at temperatures up to about 232.2 degrees Celsius (about 450.0 Fahrenheit). In one particularly advantageous embodiment, the dye-laden material may be heated at a temperature up to about 182.2 degrees Celsius (about 360.0 Fahrenheit). In addition, the curing time may be set to provide one or more particular attributes of the material. As a result, the initial temperature of a dye-laden material as well as a maximum or minimum temperature affecting color change (hereafter referred to as a “final temperature”) may be established according to the particular dye(s) used and the curing parameters applied, namely the curing temperature and curing time.

In operation, a thermochromic dye such as thermochromic printing ink may be applied to a material and cured at a temperature and for a duration effective to provide a desired first visible color of the material at an initial temperature. For example, to produce a double-layered thermochromic printing ink material having a first desired visible color at temperatures below about 22.0 degrees Celsius (about 71.6 degrees Fahrenheit), a particular printing ink may be selected and the ink-laden material may be cured at a temperature up to about 182.2 degrees Celsius (about 360.0 degrees Fahrenheit) for about two to about five minutes. In another example, to produce a double-layered thermochromic printing ink material having a first desired visible color at temperatures below about 27.0 degrees Celsius (about 80.6 degrees Fahrenheit), a particular printing ink may be selected and the ink-laden material may be cured at a temperature up to about 182.2 degrees Celsius (about 360.0 degrees Fahrenheit) from about two to about five minutes. Curing may be accomplished via an oven or like means. In one particular embodiment, to produce a thermochromic printing ink providing a first visible color of yellow at temperatures below about 22.0 degrees Celsius (about 71.6 degrees Fahrenheit), a double-layered thermochromic printing ink material may be allowed to fully air dry at an ambient temperature ranging from about 15.6 to about 37.8 degrees Celsius (about 60.0 to about 100.0 degrees Fahrenheit). Without limiting the invention, a double-layered thermochromic printing ink material may fully air dry at the above temperature range at a rate of from about 2.0 hours to about 5.0 hours depending on the ambient temperature.

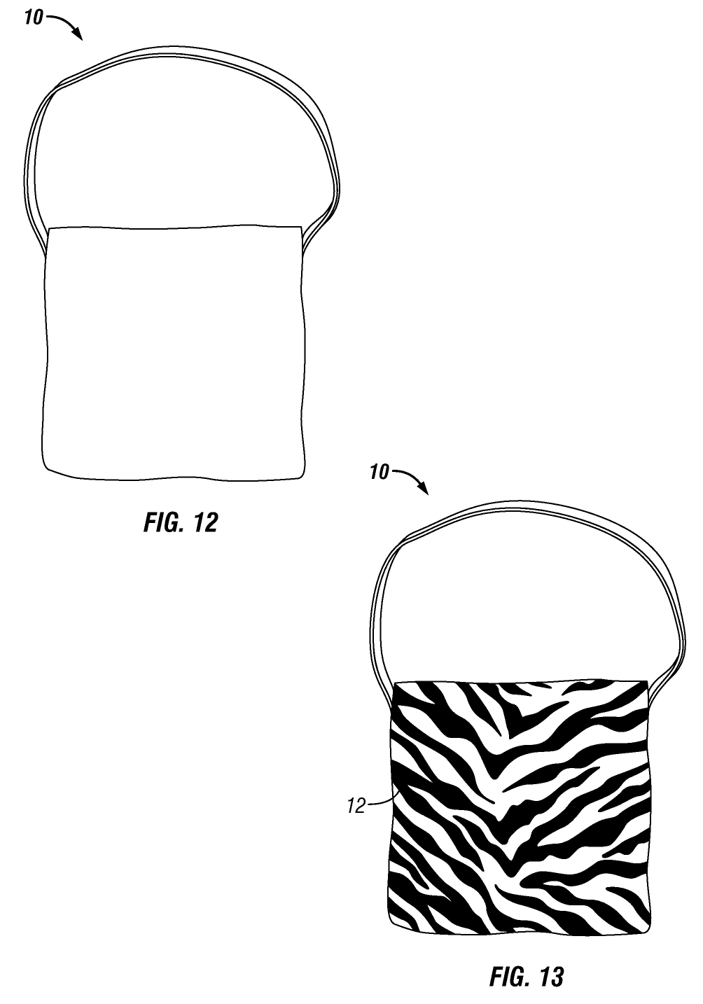

It is contemplated herein that the carrier 10 of the present application may also be constructed from any combination of color changeable materials and non-color changeable materials in a manner effective to provide any visible surface appearance of a carrier 10 as desired. In one example, particular sections of a carrier 10 may be constructed from color changeable materials whereby the non-color changeable sections of the carrier 10 maintain a constant color or colors during carrier 10 operation (see FIGS. 8 and 9 wherein the handle and pocket of the carrier 10 may change from white to black upon the occurrence of a trigger event). In another example, color changeable material may be added to a carrier 10 in a manner effective to produce a word(s), name(s), sign(s), symbol(s), and combinations thereof upon the occurrence of a trigger event (see FIGS. 10 and 11 including color changeable material in the form of a peace sign 12). In still another example, color changeable material may be added to a carrier 10 in a manner effective to produce a particular pattern, e.g., animal print, pattern camouflage, or other print design, upon the occurrence of a trigger event (see FIGS. 12 and 13 including color changeable material 12 added to a carrier 10 providing a zebra stripe pattern). The color changeable materials may also be applied to a carrier 10 in a manner effective to display a person's name, address and/or other information under certain ambient conditions. For example, in the case of a theft or loss of a carrier 10, an owner may apply a heat pack or a cold pack to the color changeable material of the carrier 10 in question whereby the information not visible at an initial temperature is realized at a final temperature.

It is further contemplated that one or more color changeable chemicals may be used to provide for reflective surfaces of a carrier 10. It is also contemplated that color changeable material may be provided in releasable form. For example, the zebra stripe sections illustrated in FIG. 13 may be attached to a carrier 10 via hook-and-loop fasteners, snaps, ties, transparent pockets, and combinations thereof. In another embodiment, a color changeable material may be applied to a pre-existing carrier 10 in a manner effective to provide a color changeable outer surface or skin of the carrier 10, e.g., a slip-on color changeable material applied to a leather tote bag.

In other embodiments, where a color-changeable material includes a first visible color at an initial temperature, the first color may become deeper in color as the material is subjected to lower ambient temperatures. For example, where a royal blue carrier 10 constructed from an ink-laden material having an initial temperature of about 22 degrees Celsius (about 71.6 degrees Fahrenheit) or below is subjected to a temperature of about 16.0 degrees Celsius or less (about 60.8 degrees Fahrenheit or less) the carrier 10 may change to a dark blue or navy blue as understood by persons of ordinary skill in the art of color.

The invention will be better understood with reference to the following non-limiting examples, which are illustrative only and not intended to limit the present invention to a particular embodiment.

### Example 1

In a first non-limiting example, a nylon material is dyed with a thermochromic printing ink to provide a color changeable nylon backpack 10 defined by one or more first visible colors at an initial temperature and one or more second visible colors visible at a different ambient temperature. Prior to assembly of the backpack 10, about 2.0 liters of the thermochromic printing ink is applied to a piece of nylon about 1.5 m² (about 5 ft²) via a roll-on technique until the nylon surface is no longer visible producing a plurality of layers of the thermochromic printing ink on the nylon surface. The ink-laden nylon is dried at a constant ambient temperature from about 30.0 to 60.0 degrees Celsius (about 86.0 to 140.0 degrees Fahrenheit) for about three to five hours.

### Example 2

In a second non-limiting example, a thermochromic printing ink is applied to the surface of a white colored nylon material at an ambient temperature ranging from about 30.0 to about 60.0 degrees Celsius (about 86.0 to about 140.0 degrees Fahrenheit) via a roll-on technique for about three minutes substantially covering the white nylon surface. The ink-laden nylon is air dried in ambient conditions up to about five hours. The nylon material is then used to construct a desired carrier 10.

### Example 3

In a third non-limiting example, two separate heavy-duty 600 denier polyester materials are provided for producing a duffle bag such as the type used by athletes to carry sports related equipment, uniforms, and the like. The duffle bag is to include a two color scheme of red and blue representing the colors of a particular sports team.

The first polyester material is dyed with a first thermochromic printing ink providing a color changeable polyester material of an initial blue color operationally configured to change to red at a predetermined activation temperature. The second polyester material is dyed with a second thermochromic printing ink providing a color changeable polyester material of an initial red color operationally configured to change to blue at a predetermined activation temperature. Once cured, the materials are combined together to provide a duffle bag having a blue body comprised of the first material with red handles and red trim comprised of the second material.

During operation of the duffle bag, once the ambient activation temperature is realized for each ink-laden material of the duffle bag, the body of the duffle bag changes from blue to red and the handles and trim of the bag change from red to blue.

### Example 4

In a fourth non-limiting example, the backpack 10 of Example 1 is provided. At an indoor ambient temperature of about 22.2 degrees Celsius (about 72.0 degrees Fahrenheit) an individual presses his/her hand upon the surface of the backpack 10 for a period of time from about 5.0 seconds to about 10.0 seconds in a manner effective for the backpack material 10 to change from a first visible color to a second visible color at the points of contact between the hand and backpack 10 surface. The second color remains visible for a period of time from about 30.0 seconds to about 60.0 seconds before reverting back to the first visible color.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

We claim:

1. A color changeable carrier constructed from at least one dye-laden material, wherein the dye-laden material is treated in a manner effective to provide one or more first visible colors under predetermined ambient conditions and one or more second visible colors under different predetermined ambient conditions.

2. The carrier of claim 1 wherein the material is selected from the group consisting of woven and nonwoven textiles.

3. The carrier of claim 1 wherein the material includes at least two layers of dye applied to the material via a technique selected from group consisting of spraying, soaking, brushing, rolling on, dipping, blotting, and combinations thereof.

4. The carrier of claim 3 wherein treatment includes curing the dye-laden material at an ambient temperature until dry.

5. The carrier of claim 3 wherein treatment includes curing the dye-laden material at a temperature up to about 182.2 degrees Celsius.

6. The carrier of claim 4, wherein the ambient temperature ranges from about 15.6 to about 37.8 degrees Celsius.

7. The carrier of claim 1 wherein the one or more dyes include thermochromic dyes, photochromic dyes, and combinations thereof.

8. The carrier of claim 3 wherein the one or more dyes includes thermochromic dye operationally configured to react chemically at temperatures ranging from about −35.0 to about 125.0 degrees Celsius.

9. The carrier of claim 1 wherein the dye-laden material changes from the one or more first visible colors to one or more second visible colors in a period of time from about 5.0 seconds to about 180.0 seconds.

10. The carrier of claim 5 wherein the dye-laden material changes from the one or more first visible colors to one or more second visible colors in a period of time from about 5.0 seconds to about 180.0 seconds.

11. A carrier constructed at least in part from one or more thermochromic dye-laden materials, the thermochromic dye-laden material being disposed along the outer surface of the carrier in a manner effective to produce one or more first visible colors at ambient temperatures ranging from about −35.0 to about 125.0 degrees Celsius.

12. The carrier of claim 11 wherein the one or more thermochromic dye-laden materials are releasably attachable to the outer surface of the carrier.

13. The carrier of claim 11 wherein the one or more thermochromic dye-laden materials are effective to produce a visual color pattern different from the one or more first visible colors at temperatures of about 22° C. or greater.

14. The carrier of claim 11 wherein the one or more thermochromic dye-laden materials include one or more rolled on layers of thermochromic dye substantially covering the surface of the material.

15. The carrier of claim 11 wherein the one or more thermochromic dye-laden materials are defined by a first visible color and a second visible color at an initial ambient temperature, whereby upon reaching an ambient activation temperature the first visible color changes to the second visible color and the second visible color changes to the first visible color.

16. The carrier of claim 12 wherein the surface area of the one or more thermochromic dye-laden materials is less than the surface area of the outer surface of the carrier.

17. A method of producing a color changeable carrier including:
providing one or more textile materials and one or more thermochromic dyes;
applying one or more layers of thermochromic dye to the surface of the one or more textile materials in a manner effective to substantially cover the surface of the one or more textile materials;
curing the one or more textile materials in a manner effective to provide one or more first visible colors of the materials at a particular ambient temperature; and
assembling the one or more textile materials to form a carrier.

18. The method of claim 17 wherein the one or more textile materials are heated at a temperature up to about 182.2 degrees Celsius from about two to about five minutes.
